(19) United States
(12) Patent Application Publication
(10) Pub. No.: US 2010/0268584 A1
(43) Pub. Date: Oct. 21, 2010

(54) System and Methods for Marketing and Advertising Referral over a Communications Network

(76) Inventors: Vijay Prasanna Pullur, Sunnyvale, CA (US); Jay Raghavendra Pullur, Hyderabad (IN)

Correspondence Address: CENTRAL COAST PATENT AGENCY, INC, 3 HANGAR WAY SUITE D, WATSONVILLE, CA, 95076, US

(21) Appl. No.: 12/616,986

(22) Filed: Nov. 12, 2009

Related U.S. Application Data
(60) Provisional application No. 61/170,866, filed on Apr. 20, 2009.

(51) Int. Cl. G06Q 30/00; G06F 3/048; G06F 15/16

(52) U.S. Cl. 705/14.16; 715/738; 705/14.4

(57) ABSTRACT

Accordingly, in an embodiment of the present invention, a system for sharing interactive electronic information with intended recipients over a network and tracking the results of interaction with the information is provided comprising an executable code installed as an executable button in an electronic form containing the electronic information to be shared, a communication channel selection interface stored on a digital medium, the communication channel selection interface displayable as a result of interaction with the button, and an activity tracking server having a digital medium for storing software and data, the tracking server including a reporting interface stored on the digital medium, the reporting interface accessible to a client sharing the information.

### CROSS-REFERENCE TO RELATED APPLICATIONS

The present invention claims priority to a U.S. provisional patent application Ser. No. 61/170,866, filed on Apr. 20, 2009. The disclosure is included herein at least by reference.

### BACKGROUND OF THE INVENTION

1. Field of the Invention

The present invention is in the field of electronic information sharing and pertains particularly to methods and apparatus for sharing Web-based information and tracking the results of propagation and use of the shared information.

2. Discussion of the State of the Art

Sharing of electronic information over a data network typically involves a person visiting a site on the internet and then physically sharing some information that they found on the site with one or more persons known to the visitor. Communications channels available to persons interacting on the Internet, for example, include Email, Instant Message, Short Message Service, Social networking sites, Social Bookmaking sites, blogs and other forms including file share programs.

The inventors are aware of a mechanism implemented as a share button that is used by some Web sites for enabling visitors to share specific information with other users by clicking on the button and selecting a communication channel over which to share the information. There are two problems in the art of sharing electronic information in its current means:

a. The website owner (marketer) cannot add additional content and also include their branding into the visitor's message. As the owner of the content knows the best way to communicate the value of what is being shared with the recipient, this renders itself as a major disadvantage in the current sharing systems.
b. Sharing electronic information does not include a capability of tracking and recording the activity related to distribution of the electronic information or the means for tracking and recording interactivity with the shared electronic information.

In electronic advertising, it is desired that a maximum number of persons have access to and interact with the advertisement. However, the current means for propagating advertisements do not contain any mechanism for tracking and recording any interactivity with distributed advertisements other than to provide link-back navigation code into the ad so that interaction causes navigation to the Web page hosting the advertisement.

Therefore, what is clearly needed is a system for sharing electronic information that solves the problems stated above by enabling Web visitors to share information with other users using selected channels and providing full tracking and recording of distribution parameters and interactivity parameters relative to the distributed information as well as to enable the website owner to add additional content and branding alongside the visitor's message.

### SUMMARY OF THE INVENTION

A problem stated above is that it is desired that the maximum number of potential users have access to interactive advertisements in electronic form; however current means for propagating such advertisements such as mass emailing also incur substantial costs, high labor requirements and questions about legality. The inventors therefore considered functional elements of an advertising system, looking for elements that exhibit interoperability; lower cost distribution properties and that would not strain advertising dollars. Moreover, the marketer has no way of adding branding or other value added content to the visitor's message being shared with others.

The numbers of responses that lead to business opportunities defines the success or failure of an electronic advertising campaign. In order to attain higher numbers of sales from responses to electronic advertising, the advertiser has to get the advertisement viewed by more users. Most electronic advertising is done from a Web site and additional methods are used to drive more people to the Web site to view the advertisements. Sending advertisements to lists of possible consumers for the product and/or service advertised is another way to advertise electronically. Most electronic advertising systems include a computing appliance connected to a network, the appliance having a digital medium adapted for storing ad data in graphics and textual form. Advertisement servers, Web page ad locations, and ad interaction monitoring means are typically part of such apparatus.

The present inventors realized during an inventive moment that if, at the point of visiting the advertisement host, if visitors were empowered and incensed to propagate the advertisement data amongst their peers, higher numbers of viewers of the advertisement might result and if the interactive results could be monitored and recorded, much information about the demographics of a distributive ad campaign might be made available to the client owning the advertisement or advertisement space. The inventors therefore constructed a unique system for enabling visitors to share advertisement data with their peers in a manner that allowed the peers to fully interact with the advertisement data and share the data amongst their own sets of peers. A significant up tic in the numbers of persons exposed to the advertisement results with no increase in advertising costs.

Accordingly, in an embodiment of the present invention, a system for sharing interactive electronic information with intended recipients over a network and tracking the results of interaction with the information is provided comprising an executable code installed as an executable button in an electronic form containing the electronic information to be shared, a communication channel selection interface stored on a digital medium, the communication channel selection interface displayable as a result of interaction with the button, and an activity tracking server having a digital medium for storing software and data, the tracking server including a reporting interface stored on the digital medium, the reporting interface accessible to a client sharing the information. A visitor to the electronic form containing the electronic information executes the code by interacting with the button to display the communications channel selection interface, and selects a communications channel from within the interface for sharing the electronic information with one or more persons and wherein the code executes to format and insert the electronic information into the selected communication channel vehicle and wherein information distribution parameters and any resulting interaction with the shared information is tracked and recorded by the tracking server and made accessible to the client.

In one embodiment the electronic information includes one or more graphics displays, one or more text lines or blocks, URLs or hyperlinks. In one embodiment the electronic information includes navigational instruction for a recipient's browser to access the original location of the electronic information. In one embodiment the one or more persons are contacts displayed from a third-party contact list relevant to the selected communications channel.

In one embodiment the electronic information is contained on a Web page and the executable button gathers the electronic information and formats the information for suitable display according to the communications channel selected for sending the electronic information. In this embodiment the electronic information includes one of a Web image or a flash based image.

In one embodiment the electronic information is an advertisement enabled for click-through interaction and includes a tracking code for tracking click-though activity. In one embodiment the electronic information includes sender identification data and a tracking code for tracking the identification data of one or more persons that the electronic information was shared with. In one embodiment the reporting interface enables graphical views of collected statistics about usage of the executable button and about resulting activity relative to remote interaction with the distributed electronic information.

In one embodiment interaction with the electronic information at the point of a person receiving the electronic information causes re-direction of the person's browser to the original form containing the electronic information. In one embodiment the electronic information is a dynamic advertisement provided to the electronic form by an advertising server and wherein the executable button is automatically refreshed each time a different advertisement is served to the electronic form.

According to one aspect of the invention a method for advertising is provided comprising the steps (a) providing at least one advertisement in electronic form, (b) associating to the advertisement, an executable button for gathering and utilizing data relative to the advertisement and use thereof, and (c) facilitating through the executable button, communication of the advertisement data in interactive format to one or more intended recipients.

In one aspect of the method in step (a) the advertisement is one of a static graphical advertisement, a java script graphical advertisement, or a flash based graphical advertisement. In this aspect of the method the graphical portion of the advertisement is a still graphic or an animation. In one aspect of the method in step (b) the executable button is overlaid onto the advertisement graphics. In another aspect in step (b) the executable button is placed adjacent to but not touching the advertisement graphics.

According to another aspect of the present invention a method for facilitating a referral through propagation of an electronic advertisement is provided comprising the steps (a) providing an advertisement in electronic form, (b) associating to the advertisement, an executable button for gathering and utilizing data relative to the advertisement and use thereof, (c) facilitating through visitor interaction with the executable button, communication of the advertisement data in interactive format to one or more intended recipients, (d) redirecting the one or more recipient's browsers to the original advertisement upon interaction with the advertisement data communicated to the one or more recipients, and (e) tracking and recording activity relative to one or more recipients interacting with the advertisement.

In one aspect of the method in step (b) a price structure including a discount for referring the advertisement is included in the data relative to the advertisement. In one aspect in step (a) the advertisement is a click-through advertisement on a Web page. In this aspect in step (e) activity includes click-through data that is recorded on a digital medium accessible to a tracking server and reporting interface.

### BRIEF DESCRIPTION OF THE DRAWING FIGURES

FIG. 1 is an architectural overview of a communications network supporting sharing of interactive content according to an embodiment of the present invention.

FIG. 2 is a block diagram illustrating components of the present invention and intractability thereof according to an embodiment of the present invention.

FIG. 3 is an exemplary screen shot of a communication interface according to an embodiment of the present invention.

FIG. 4 is an exe3 mplary screenshot of a communication selection interface according to an embodiment of the present invention.

FIG. 5 is a process flow chart illustrating steps for sharing content according to an embodiment of the present invention.

FIG. 6 is an exemplary screen shot of a Web page containing content for sharing and a communication interface for sharing the content according to an embodiment of the present invention.

FIG. 7 is an exemplary screen shot of a service interface for interacting with the service of the present invention.

### DETAILED DESCRIPTION

The inventors provide a system for enabling a network-connected visitor to share content including advertising with intended recipients over a network using any desired electronic communication channel and protocol. The system provides an executable button embedded in, overlaid on or located proximally to the content for sharing, where the executable button is selected to initiate a sharing of content. In some embodiments the shared data is interacted with and the interaction is tracked by the system. The present invention is described in enabling detail in the following examples, which may include description of more than one embodiment of the invention.

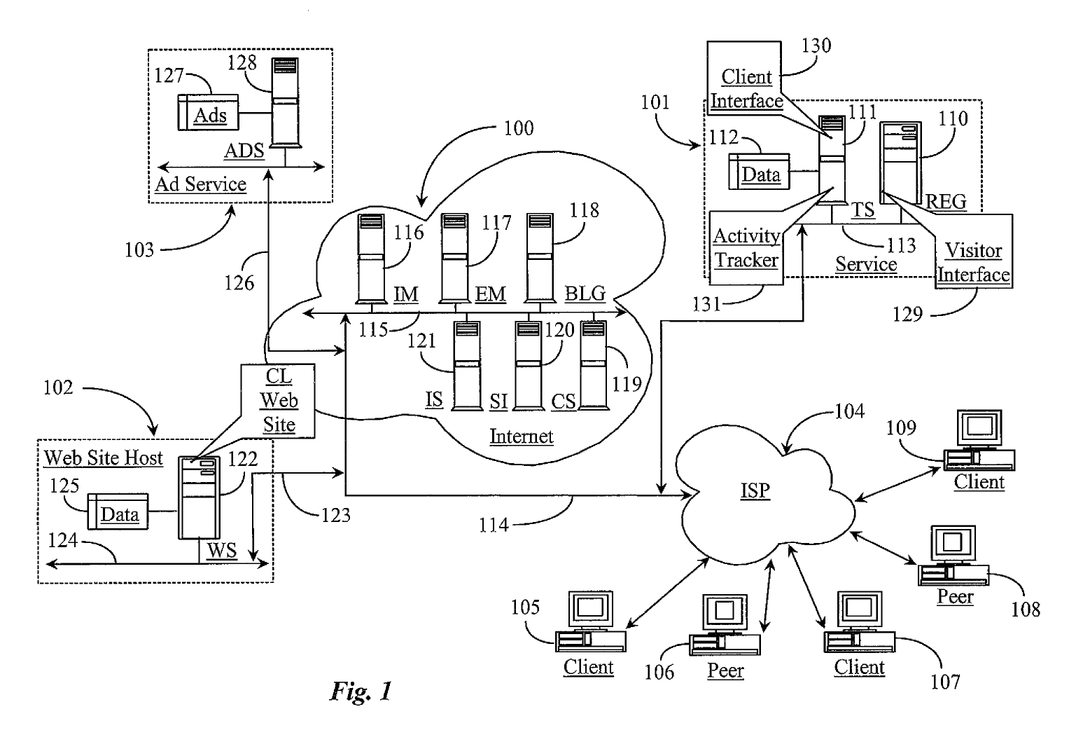

FIG. 1 is an architectural overview of a communications network supporting sharing of interactive content according to an embodiment of the present invention. A communication network 100 is illustrated in this example and comprises the Internet network in a preferred embodiment. Network 100 will be referred to hereinafter as Internet 100. Internet 100 is further illustrated herein by an Internet backbone 115, which represents all of the lines, equipment, and access points that make up the Internet network as a whole. Therefore there are no geographic limitations to the practice of the present invention.

A service provider illustrated herein as service 101 provides the service of the present invention to service clients who have electronic information that they would like to share with others. Service 101 is illustrated outside of Internet cloud 101, but one with skill in the art will appreciate that the Internet includes connected sub-networks adapted for Transfer Control Protocol over Internet Protocol (TCP/IP) and other applicable Internet protocols. Service 101 includes a local area network (LAN) 113 adapted for Internet traffic and connected to Internet backbone 115 by an Internet access network including access line 133 and access line 114. LAN 113 supports a registration server (REG) 110 that is used to register clients for practicing the present invention. Registered clients are represented in this example as a client 105, a client 107, and a client 109 all having Internet access through an Internet Service Provider (ISP) 104 connected to backbone 115 by Internet access network line 114. For purposes of definition, a client of service 101 is someone who has electronic data hosted on the Internet network that he or she wants to share with as many other persons as is possible. For example, a client may have a Web page including advertising for a product or service the client provides. Thus the client wishes to share this information virally.

Registration server 110 has a digital medium provided therein or otherwise accessible thereto (medium not illustrated) for storing data and software (SW) to enable suitable server function in accordance with the present invention. Registration server 110 has a visitor interface (SW) application 129 that may be accessed from remote network locations such as through a Web site link, for example. More detail about interface 129 is explained later in this specification. LAN 113 in service domain 101 supports a tracking server (TS) 111 that is adapted to track activity relative to any shared content. Server 111 has a connected data repository 112 that is adapted to store data relative to client and visitor activity and recipient activity relative to any shared content that might be interacted with after receipt. An activity tracker SW application 131 is provided for this purpose. Tracking server 111 may also include a digital medium internal to the server, which may be adapted for task performance, regular server function, and to store executable server SW.

Data stored in repository 112 may include any client-based data and all tracked activity data occurring as a result of service practice. Tracking server 111 includes a client interface (SW) application 130 adapted to enable service clients to order statistical views of data stored in data repository 112, the views representative of analytics and statistics related to tracked activity.

A Web site host 102 is illustrated in this example and has Internet connectivity through a data network comprising network access line 123 and Internet access line 114. Web site host 102 includes a LAN 124 adapted as described above for Internet usage. Host 102 maintains a Web server 122 connected to LAN 124, which is accessible to Internet patrons as a normal Web server serving electronic information pages to requesting computer appliances having Internet connectivity. Web server 122 includes a digital medium provided therein or externally connected thereto for enabling server function and for storing Web data served through Web sites for a multitude of clients using the host to publish information. An exemplary client Web site is illustrated herein as Web site 132.

Web server 122 includes a data repository 125 adapted to contain data relative to clients using the server to host their Web sites. Clients may include corporate clients, small business clients, and individual clients who maintain Web sites hosted with server 122 like Web site 132 for example. Web server 122 is accessible from the Internet over backbone 115 and a data network including Internet access lines 123 and 114. In one embodiment of the present invention Web site 132 includes data for sharing that a client belonging to the service of the present invention wants shared with others. A particular type of data that a client would want shared with as many persons as possible is advertisement data.

An advertisement service 103 is illustrated in this example and is adapted to provide static and dynamic advertising to Internet clients. Ad service 103 includes a LAN 134 adapted for Internet protocols that has Internet connectivity via a data network including Internet access lines 126 and 114. LAN 134 supports an advertisement server (ADS) 128 adapted to serve electronic advertising. Server 128 includes a connected data repository 127 adapted to contain advertisements for service. Server 128 may also include an internal digital medium for containing data and SW to enable server function as an advertisement server.

Internet network 100 includes a variety of communications servers connected to backbone 115. Communications servers include an Instant Messaging (IM) server 116, an Email (EM) server 117, a Blogs (BLG) server 118, an Information Server (IS) 121, a Social Interaction (SI) server 120, and a Chat Server (CS) 119. All of the communications servers just introduced may include digital mediums provided therein or otherwise made accessible thereto for storing data and SW for enabling respective server function. The communications servers 116-121 represent communication channels on the Internet network through which information may be shared directly and, in some cases indirectly with other persons.

In this example, clients of service 101 such as clients 105, 107, and 109, may, using the service of the present invention, empower Web users such as Web page “visitors”, for example to share data with their peers. In this example recipients of shared data or peers are represented herein as a peer 106 and a peer 108. Clients and content visitors may use the service of the invention to share data directly with other peers using a selected communications channel such as are represented in Internet cloud 100. Clients and peers represented herein as elements 105-109 connected through ISP 104 may use any Internet capable appliance to practice the invention as long as it supports at least one Internet based communication channel like Email, Multimedia Messaging Service (MMS), Instant Messaging (IM), Chat, or other communication channels that are less direct like MySpace™, or similar social interaction pages where users maintain profiles and have access to contacts. The invention may be practiced using a personal computer, a cellular telephone with Internet capability, a Laptop or Notebook computer, a Personal Digital Assistant (PDA) or other appliances that can be used to access the Internet.

In one embodiment of the invention a client such as client 105 has a Web site like Web site 132 through which the client advertises products for sale. The client may register with the service of the invention at REG 110. The service of the invention provides the client with an executable code manifesting as an executable button that can be associated with the relevant data that the client wishes to share such as an advertisement for example. The service or the client may install the button on a Web page advertisement of the client Web site or some other content from the site that the client wants to share. The service may embed the button into the advertisement, overlay the button over the advertisement or install it separately from the advertisement but associated with the advertisement data. The inventors know the executable button as a “Tell a Friend” button.

A visitor to the client's Web page such as peer 106, for example may, while visiting the client's Web site, click on an executable button associated with the shared content to execute and display visitor's interface 129. Visitors interface 129 enable the visitor to select a communications channel and to import any contacts associated with the selected channel. In one embodiment the visitor's personal communication interface may be customized by the addition of a “skin” that may be designed in the likeness of the Web page and content that is to be shared. While the visitor operates the interface to select a communication channel and recipients of the shared content, the code operates to insert the shared content in a format suitable for the selected communication channel. The insert task includes formatting the graphic display of the content, formatting any text blocks associated with the content, and maintaining the original interactive mechanics of the shared content so that the recipient may interact with the content while connected to the Internet from within the communications interface that receives or otherwise displays the content to the recipient.

Each time a visitor clicks the executable button, another visitor interface is spawned for that visitor to select their preferred communications service. One incentive for inciting visitors to share information is to provide discounts for the activity. In one embodiment the visitor interface (129) includes a contact import wizard that may be used to access the contacts of a visitor from the site of the communications channel host for the visitor. For example, if the visitor selects an Instant Message Access Protocol (IMAP) Email program such as Yahoo Mail™, for example, all of the visitor's listed contacts may be imported from the site after the visitor provides the correct login information to access the site. Visitor interface 129 may import the contacts and the visitor may select from the contacts those that will receive the shared content.

Visitor interface 129 may, after all of the required information has been acquired, generate a message containing the interactive content addressed to the intended recipients and the visitor, once satisfied with the message, can then send the message. A communications channel may vary widely in protocols, content formatting, and actual propagation parameters. Therefore, visitor's interface 129 is designed to support all of the viable communications channels that can be utilized over the Internet.

Tracking server 111 with the aid of activity tracker 131 monitors and tracks all of the activity including how many hits the content receives for sharing, and how many visitors have shared the content with how many peers. Activity tracker 131 may also be adapted to track any interaction with the shared content at the recipient end by virtue of install of special tracking links that lead back to the tracking server and report to application 131. All of the instant and tracked data is stored in data repository 112 for further use and study. Client interface 130 is provided for the client so that the client may periodically view the activity that has occurred around the content that visitor's are sharing with their friends. Client interface 130 can, for example, count click-through on click through advertisements. Provide statistics about the ratio of visitors to shares. For example, today there were 120 visitors to the content and 60 visitors clicked the button to “Tell a Friend” so the share ratio is about 50% in that example.

The code underlying the Tell a Friend executable button is adapted to gather or collect all of the shared content including interactive functionality of the shared content so that it may be interacted with and tracked from the point of the Web page (in this example) to the point of the recipient. For example, if a peer receives an Email from a peer and the email contains a banner advertisement from the site, all of the interactivity of that advertisement is preserved so that it is in essence, an extension of the Web site. Clicking on the ad at the recipient's computer will direct the recipient to the next step normally generic to the Web site. Links may be installed by the code to the original Web site, to the tracking server, and to the registration server if desired. The effect is that the Email message containing the interactive advertisement is now part of the client's Web page.

It is noted herein that the visitor interface 129 may be executed from and run on tracking server 111 instead of registration server 110 without departing from the spirit and scope of the present invention. The location on the registration server is logical only as the components of the invention may reside on one digital medium and may be executed from one server machine. Client interface 130 may be integrated with reporting SW services offered by Web site host 102 as part of available hosting services.

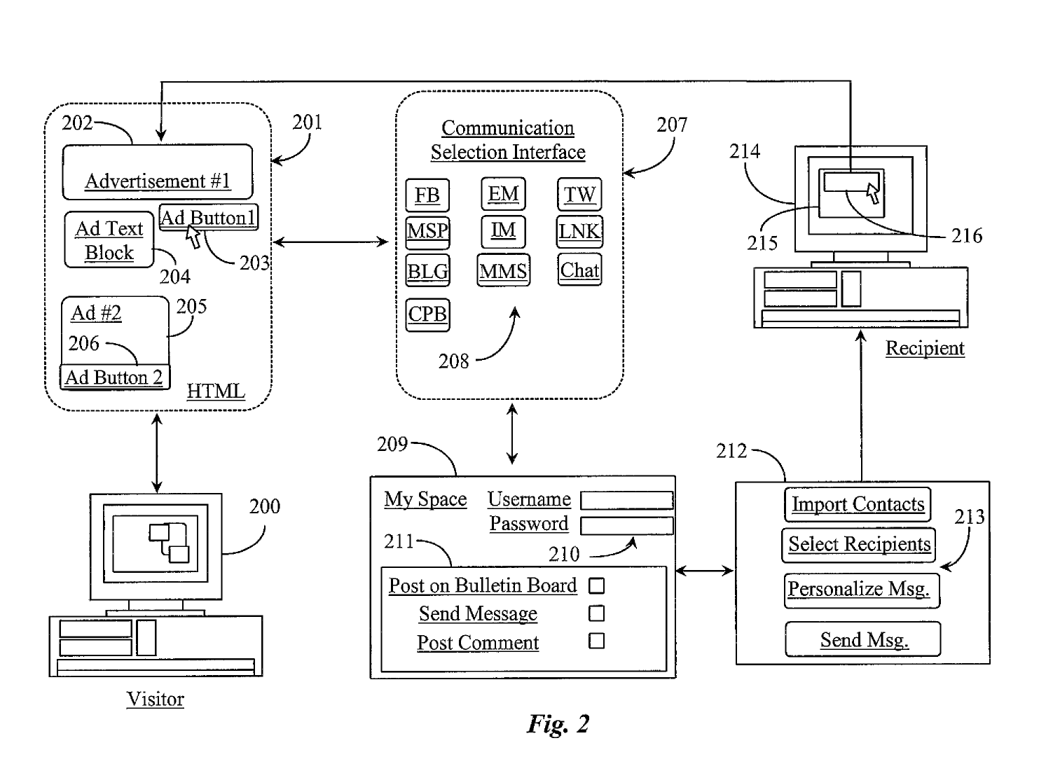

FIG. 2 is a block diagram illustrating components of the present invention and intractability thereof according to an embodiment of the present invention. A visitor 200 is illustrated in this example as a computer icon representing one possible appliance that may be used to practice the present invention. Visitor 200 is analogous to peer 106 or peer 108 of FIG. 1. In one embodiment visitor 200 visits a Web page (HTML) 201 of a client registered with the service of the invention. Web page 201 is analogous to a page from client Web site 132 hosted on WS 122 of FIG. 1.

Web page 201 has a first advertisement 202. A first advertisement indicium 203 is provided adjacent to advertisement #1 is this example. Ad button 1 may be overlaid on advertisement #1 or it may be embedded into advertisement #1. An advertisement text block 204 is provided on Web page 201 and is associated with advertisement #1, which is a graphical advertisement like a banner ad, for example. Text block 204 describes advertisement #1 and provides additional information about the advertised service or product. Ad button 203 is code that enables execution of a communication selection interface illustrated herein as communication selection interface 207 and analogous to visitor interface 129 of FIG. 1. Ad button 203 is programmed to capture all of the coded data of advertisement 202 and text block 204 in this example as the content to be shared with another user.

Page 201 also has a second advertisement 205 and an executable advertisement button 206. If advertisement 201 and advertisement 205 including text block 204 are intended to be shared together, than only one ad button like button 203 is required. In one embodiment the Web-site developer may tag content to be shared such as advertisements and associated text descriptions. The ad button code acquires all of the pertinent data including interactivity options and the like ands formats the content for insertion into a selected communication message for send of the desired communications channel.

Communication selection interface 207 displays various communication channel options 208 representing communications channels that may be enlisted by visitor 200 as a vehicle or vehicles to share the content defined in the code. A visitor may already be subscribed to all of or some of the communications channels that are hosted by third-party services. If a user wants to use a channel that he or she has no subscription to the communications selection interface may provide a link to the third party service hosting the communications channel where the user may subscribe to the service and set up an account. In this way, each of the third-party services cooperating with the provider of the service of the invention may get more subscribers.

Reading from left to right in options 208, the first row includes Facebook™ (FB), Email (EM), and Twitter™ (TW). If a user selects Email in communication channel options 208, then another window may appear offering several Email options to choose from. In the second row of options 208 the channels MySpace™ (MSP), Instant Message (IM), and LinkedIn™ (LNK) are represented. Selecting IM may bring up an additional window providing the granular options for which IM interface will be used, for example Yahoo Messenger™ or AOL Instant Messenger™ (AIM). Selecting MySpace™ or Facebook™ may bring up a window that provides further options for communicating like using messaging from within the MySpace interface to send the content to a friend, or perhaps posting the content to a MySpace bulletin and so on.

In the third row of channel options 208 there is a Blogs channel (BLG), a multimedia-messaging channel (MMS), and a Chat channel. Selecting any of these options may bring up windows detailing further options like identifying a cellular telephone carrier for the MMS option, or if the visitor is browsing the site with a cellular telephone the service may recognize the appliance and automatically present the appropriate options 208 for that device. The last listed option 208 is a community posting board (CPB) that may be accessed, for example, through a news reader or some community oriented Web portal.

In one embodiment a visitor may select more than one channel and have the content inserted into communication events generic to the channels selected thereby enhancing the viral effects of sending the content to peers. Once visitor 200 selects a channel option 208, a communication interface 209 displays on the visitor's computer wherein the interface is generic to the channel selected and, in one embodiment dressed in a custom or standard theme of the Web site of the client where the content shared is sourced. This feature may be controlled by the client whereby the client may select a skin for a selected communication channel interface that was created from the graphical theme of the advertisement page or Web site of the client. In this way the visitor sharing the content appears dedicated to or otherwise personally connected to the content being shared.

Communications interface 209 is a MySpace™ interface in this example and includes a login interface 210 for the visitor to perform a login procedure to qualify to send the content through the MySpace™ service. A further list of communications options 211 is illustrated within interface 209 where each item in the list has an associated radio button that enables the visitor to select which channel or channels to use. In this example the available channels through MySpace™ are a bulletin board posting, sending a message to a friend on MySpace™, or posting a comment on a friends MySpace™ page. The last option enables the visitor to post the entire interactive content on the friends comment space under a photo, blog, or in a general comments space.

Once visitor 200 is logged into MySpace™ and has selected one or more communication options, a contact wizard 212 may display for the visitor that presents further options 213 among which may enable the visitor to import a contact list for the purpose of selecting one or more recipients for the content from, in this case, the visitor's friends list on MySpace™. One option 213 enables the visitor to personalize the message through which the content is shared or posted. Selecting this option may bring up a generic text entry field for adding the personal message that may be displayed along with the shared content. A final option 213 enables the visitor to send or submit the information.

In this example, the user logs into the third-party service for authentication only and does not actually visit the Web-based service or any friend's spaces on the service. The service of the present invention acts as a proxy for the user and initiates the communications on behalf of the user. In another embodiment the service may be configured to allow a visitor to use the actual MySpace™ communications options launched from the MySpace™ page. In the first case the third-party service allows the service host of the invention to utilize the service on behalf of the authenticated visitor without requiring the user to navigate to the page. The second case enables the visitor to access the appropriate site upon login and select an option from the site menu for submitting the content. In this case the content is inserted into the actual third-party generic interface.

A recipient 214 is illustrated in this example as a computer icon representing just one of the possible appliances that may be used to practice the present invention. Recipient 214 receives the shared content identified as coming from the visitor as the sender of the content. The content is received in an interface 215 that may represent the recipient's communication interface or in this case, a MySpace™ page. In this example, a fully interactive advertisement 216 is displayed along with any other personal information or added text data in a format that the recipient may easily read and interact with. For example, if the recipient clicks on the advertisement graphic 216, the user may be redirected to the original Web site of the client for further interaction. In this case the act of clicking the advertisement is traceable and may comprise a first step in a purchase process at the original Web site. Therefore, upon interacting with the advertisement, the recipient 214 is redirected to the Web page and to the next step in the process. The interaction with the advertisement graphic is recorded at the service such as in tracking server 111 aided by activity tracker 131 OF FIG. 1.

In this case the advertisement data contains an embedded link back to the Web site for browser redirection. The advertisement may contain a tracking cookie that reports to the tracking server application (Activity Tracker) to register one or more “clicks” on the advertisement, which may be referral enabled or enhanced such that the visitor is credited with a referral point. In one embodiment the advertisement is a click through Ad and the service of the present invention extends the tracking capability of the third party by accounting for all of the clicks on the distributed advertisements sent to peers by Web-site visitors.

In one embodiment the service of the present invention may include fulfillment options for peers that interact with a shared advertisement and proceed to purchase a product or service through interactivity with the advertisement. In this case the interfaces may be wholly created and hosted by the service of the present invention and approved for authentic use through agreement by the participating third parties hosting the communications channels and social interaction Web sites or portals. In this way the service of the invention provides sales fulfillment remotely and the user does not have to actually interact with the client Web page.

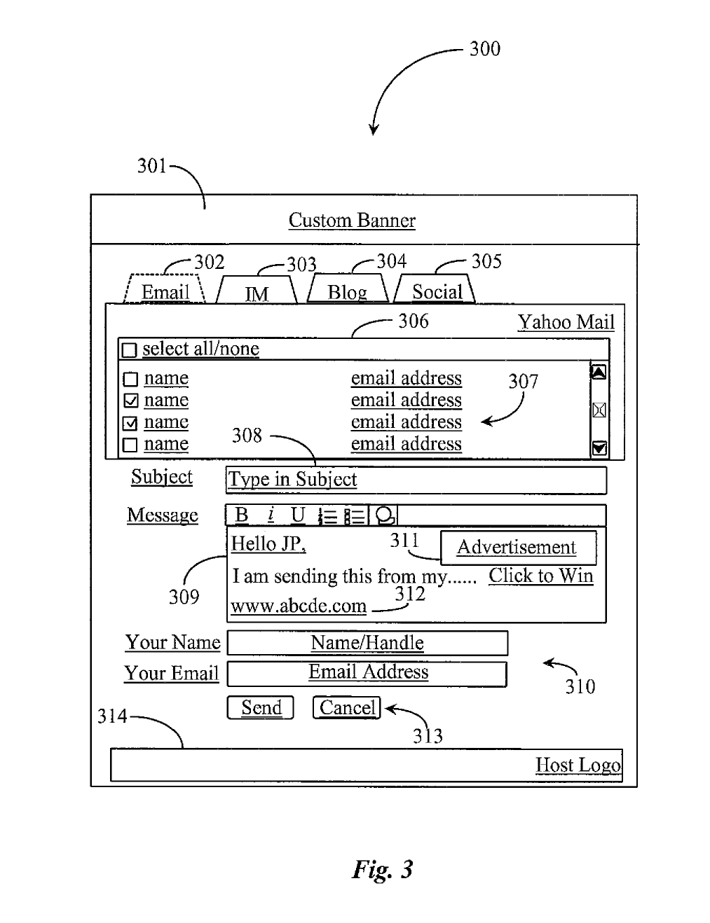

FIG. 3 is an exemplary screen shot of a communication interface 300 according to an embodiment of the present invention. Communications interface 300 is displayed for a visitor as a result of interaction with the channel selection interface described further above. Interface 300 is an Email communication interface and displays in the same window as the communication channel section interface in one embodiment. The options Email 302, IM 303, Blogs 304 and Social Interaction 305 are presented herein and option 302 (Email) is shown selected by a broken boarder. In this example it is assumed that the visitor already selected a service carrier and provider for the message. The carrier is Yahoo Mail™ in this example.

A contact list is available, having been imported to a contact window 306 for the visitor to select one or more recipients 307 to receive the shared content. In this example two contacts are selected to receive a Yahoo™ message or Email in this case. A subject line 308 is provided for entering a subject for the message. A message body 309 is provided in which the visitor may type a personal message and in which the service of the invention inserts the shared content that is formatted for display on the recipients' appliances. In this example a contest graphical advertisement 311 is inserted. A “Click to Win” link and a link 312 back to the client site www.abcde.com are associated with the advertisement.

Interface 300 includes a reply address interface 310 containing a data entry field for the visitor to input his or her name or handle and an address field for inserting a return or reply address. In this case the interface is hosted by the service of the present invention and may be dressed in graphics reflecting the service provider, the third-party service hosting the Email service, in this case Yahoo™, and in graphics that are representative of the original client Web site where the shared content resides. A custom banner 301 may be provided that reflects the trade dress of the original client Web site. A host logo may be provided on an information bar 314 at the bottom of the interface along with any added information. The host logo may be that of the service provider hosting the service of the present invention.

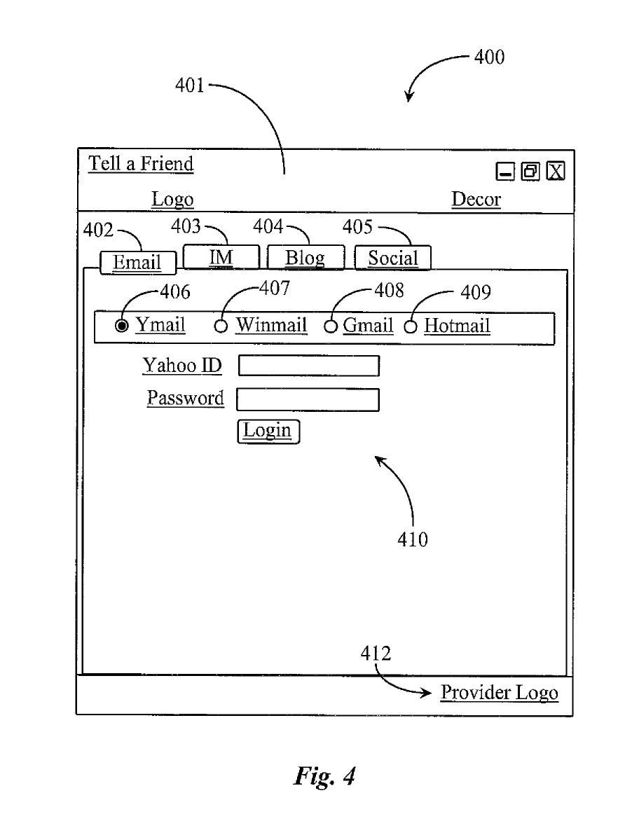

FIG. 4 is an exemplary screenshot of a communication selection interface 400 according to an embodiment of the present invention. Communication selection interface 400 includes a banner type title bar 401 that contains the title of the service, in this case “Tell a Friend” and may include a trademarked logo or other appropriate insignia. The window includes controls typically provided for closing the window, minimizing the window, and changing the size of the window from full screen to a smaller size.

Interface 400 has communication channel options Email 402, IM 403, Blogs 404, and Social Network (Social) 405. Of these channel options, the visitor selects Email. The selection results in a subsequent display within interface 400 of the Email options Ymail™ 406, Winmail™ 407, Gmail™ 408, and Hotmail™ 409. The user has selected the Ymail radio button resulting in a subsequent display of a login interface 410 for entering the visitor's Yahoo™ ID and password to authenticate the visitor as an authentic Yahoo subscriber. A provider logo 412 is inserted in the information bar at the bottom of interface 400. In this case more granular options are called into the same interface window where the last selections are still visible to the visitor. In this example the user does not access the Yahoo™ Website.

After entering the authentication information, the visitor is presented with a proxy Email interface enabled by the host of the service of the present invention. The third-party Web service may differentiate a normal user login (to access Web content) from a user authentication to share content from the client's Web site by associating the login request with interface 400 and the service host of the service of the present invention.

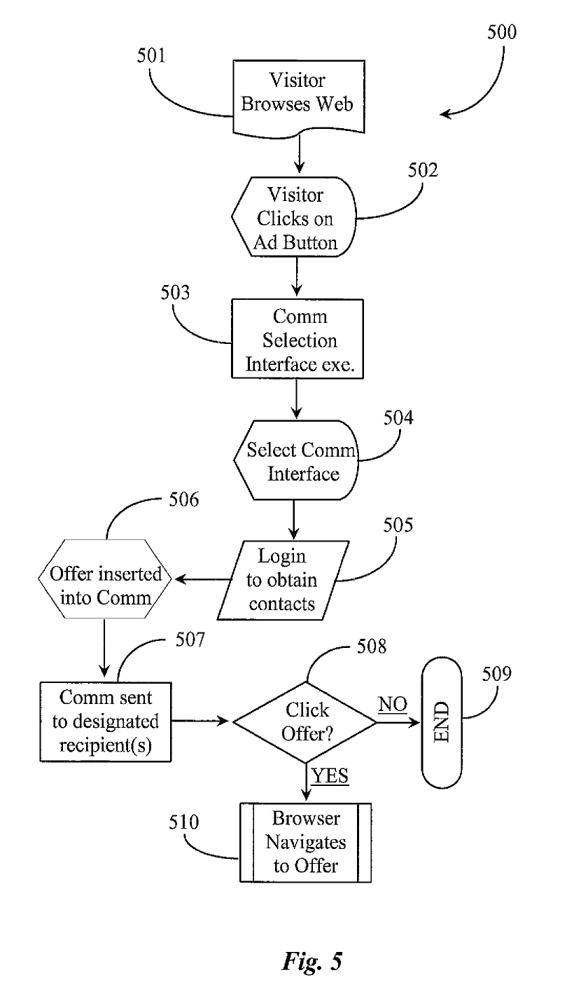

FIG. 5 is a process flow chart illustrating steps 500 for sharing content according to an embodiment of the present invention. At step 501 a visitor visits a Web page of a client who is registered with the service of the present invention. The client has content that they want shared and have enabled visitors through the service of the invention to share content over a selected communication channel with one or more peers. At step 502 the visitor viewing content may decide to click on an executable button associated with the content for sharing. The button may be embedded into the content, associated with the content or overlaid on the content. The code provided with the executable button functions to capture the sharable content associated with it and to execute a communication channel selection interface that the visitor may use to select one or more channels over which the data may be shared.

At step 503 the communication channel selection interface is executed and displays on the visitor's appliance display such as on a computer screen. At step 504 the visitor may select one or more communication channels to use to send the shared content to one or more peers of the visitor. A peer of the visitor would be someone on a contact list or in a friends list of the visitor and would have access to the same communication channel, for example, Email, Instant Message, MySpace™, Twitter™, or some other channel. It is noted herein that an Email channel may include more granular options such as selecting a particular Email provider such as Ymail™ or Gmail™ for example.

Once the specific channel is selected including the service provider hosting the channel, the visitor is provided with a login interface for the purpose of logging in to authenticate the user for the selected channel and to retrieve the contact list of peers for that channel. Email is a broad channel category while Hotmail™ is a specific Email channel. If a visitor selects Email and has more than one Email account then he or she may utilize both accounts to share the content from a single interface. At step 505 the visitor logs into each specific account to authenticate and to retrieve the relevant contact lists so that recipients may be selected to receive the shared content. Step 505 may be repeated for each different account that requires a login procedure.

At step 506 the service of the present invention inserts the content for share into the message body or other view space of the communication event interface. In one embodiment the offer may be an interactive advertisement or an interactive contest where disbursement of the content is tracked and where remote interaction with the shared content is also tracked and recorded for reporting purposes. At step 507 the visitor, having selected the recipients from the contact list, sends the communication events containing the shared content to the designated recipients. In one embodiment a peer receiving content such as an interactive advertisement may elect to click the advertisement and engage services or to refer the advertisement on to other peers for a discount. In this case the interactivity may include the options for buying without referral or buying after referral at the promised discount. In any case the interactive content formatted and inserted into the communication event contains the suitable tracking components and reporting components to enable remote tracking of any interaction with the shared content at the receiving end.

When a peer receives the shared content he or she may, at step 508, click on the content to interact with the content or the peer may decide to ignore the content for some time or may never interact with the content. If the peer ignores the content at step 508 the process may terminate at step 509. If the peer decides to interact with the content at step 508, code embedded within the content acts to redirect the peer's network navigation SW to link back to the original Web site for any further transaction processes or to perform other tasks related to the shared content such as by adding a comment, debating an issue, accepting an offer, posting an opinion, or some other task that the client wishes to see the results of. In one embodiment the content for sharing is a static or dynamic graphical advertisement that is interactive on the original Web site hosting the advertisement and may be made fully or partially interactive at the remote destination of the recipient.

Examples of interactivity may include but are not limited to mousing over the advertisement or shared content, clicking on the advertisement or shared content, blogging about the advertisement or shared content, or referring the shared content to another peer or peers. In a preferred embodiment, the system of the present invention tracks any further interaction with shared content after the content is inserted into a communication event and submitted for send to a peer. For example, if the shared content is an interactive advertisement then the system can track how many visitors have shared the content with how many peers and how many of the peers interacted with (clicked on) the advertisement or referred the advertisement on to other peers for a discount. A visitor may receive a discount on a product by clicking the ad-sharing button (termed a Tell a Friend icon or button) by the inventor. The visitor may share the advertisement with 3 persons, for example. In this regard the advertisement now appears in four locations, the original Web page and the three peer communications interfaces.

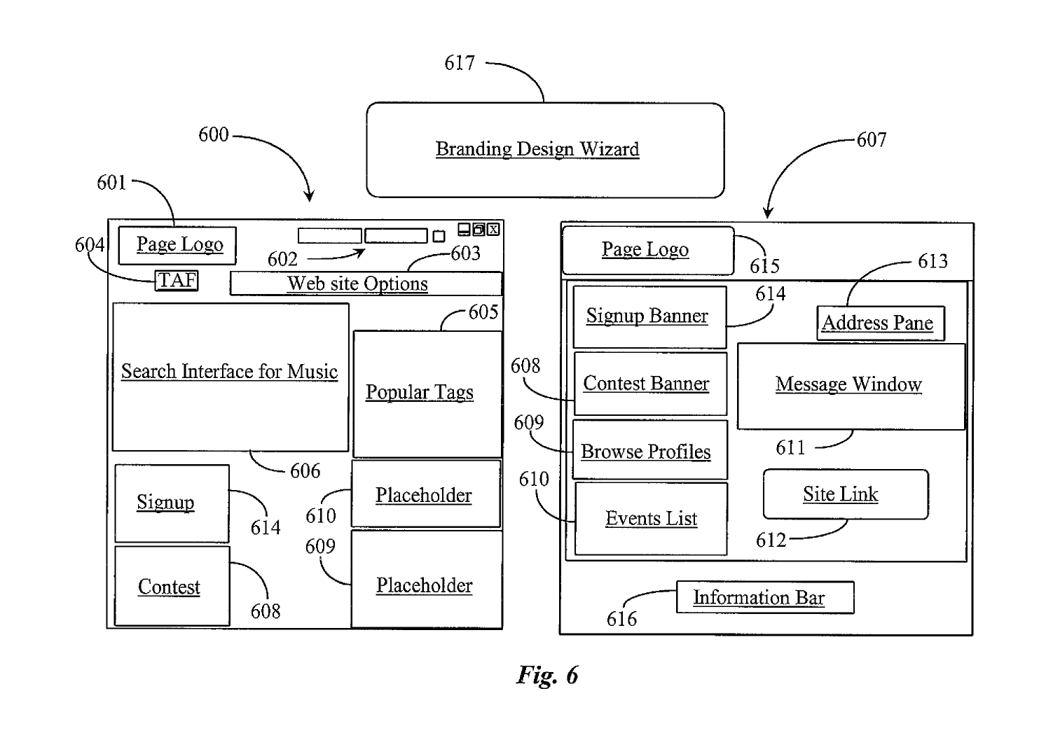

FIG. 6 is an exemplary screen shot of a Web page 600 containing content for sharing and a communication interface 607 for sharing the content according to an embodiment of the present invention. In this example, a Web page of a client is illustrated as Web page 600. Web page 600 may be a popular commercial Web site offering products and services. Web page 600 has a service logo or page logo identifying the host of the Web page. Those with normal skill in the art of marketing refer to the “look and feel” of the Web site and other trade dress as “Branding”. Web page 600 may include a login interface 602 providing a user name field and a password field for normal clients to log into the page and to access service. Web page 600 may include a number of Web site options 603 that amount to simple navigation rules, download rules, and other site options. Web page 600 includes a TAF button 604 and a list of popular search tags 605.

Web page 600 includes a search interface 606 that enables a user to search the Web site for music, video and any other data that is site maintained. Web page 600 has an interactive sign up graphic 614 and a contest entry graphic 608. Web page 600 includes a list of popular search tags used at the site to find content or resources or used from a search interface to find the site on the Internet. A placeholder 609 and a placeholder 610 represent space where dynamic content is inserted like dynamic advertisements.

Communication interface 607 represents a communication event window that has the shared content from Web page 600 inserted therein in the form of a personal message that is sent to one or more recipients from a visitor to the Web site that has clicked on the TAF executable button 604. Button 604 is analogous to buttons 203 and 206 described with reference to FIG. 2. Interface window 607 includes a page logo 615 in the likeness of the original site logo of the site hosting the content shared in order that the marketer may extend the “branding” to recipients of the message. In this example, interface 607 has a large view space that contains a message body window 611. An address block 613 is provided and associated with window 611 for addressing purposes (i.e. to and from addressing and subject line population. Window 611 may be used to ad personal comments or text to the message. A return link 612 is provided within interface 607. Return link 612 enables a peer (recipient) to navigate back to the Web site hosting the original content that was shared with the peer.

In this example TAF 604 of Web page 600 is programmed to capture and insert the content Sign up (614), Contest (608), and any dynamic information presented in placeholders 609 and 610 at the time that the TAF button 604 was executed to initiate sharing of the content. In addition to shared content, the TAF widget and any of the personal sharing interfaces and controls, in a preferred embodiment, may be dressed with the branding, logos, trademarks, and other trade dress of the site and products or services offered through the site. Branding may include graphic designs, color themes, and audio or text slogans. In this way the marketer is empowered by the service of the present invention to distribute branding through the shared messages over multiple channels.

In one embodiment the application of branding from the original site to an email or other messaging template is accomplished with a branding design wizard 617. Branding design wizard 617 contains all of the tools necessary to dress any of the displayable components of the system of the present invention with the particular branding of the marketer using the service. For example, the TAF button, communication selection interface (Widget) and messaging templates may be pre-dressed with the look and feel of the Web site including color themes, trademark designs, logos, slogans, and other trade dress.

Referring now to interface 607, sign up interactive 614 is present as well as contest interactive 608. An interactive 609 for browsing profiles and an interactive 610 for viewing events is present in the interface and represents the dynamic interactive content that was present in page placeholders 609 and 610 of the Web page at the time that a visitor clicked on TAF button 604. An information bar 616 is provided and may contain any information that the marketer wants to share with the visitor and the visitor's peers. It is noted herein that button 604 may be associated to content that is on the same page or on another page of a Web site without departing from the spirit and scope of the present invention. In a preferred embodiment however, a visitor sees something that he or she wants to share and therefore clicks on button 604 to initiate the process of sharing the information through the desired communication channel.

In this example the communication of the shared content is not restricted to containment within a message body or window. Interface 607 may contain any specified graphics and text content from Web page 600 for the purpose of sharing the content. The content may be video content, musical, blog content, photo content, advertising content, contest offers, or any mix thereof. The order and arrangement of the shared content in a communication channel interface is dictated by programmed code. In one embodiment Java Scripting is used to capture the content and to insert the content into the selected communication channel template. Additional interactive hyperlinks may be inserted into a communication event interface that links to functional controls on the Web page like audio player controls or video player controls. For example, if a visitor can access a video stream from the Web site, then the peer receiving the shared video content may also be able to access the video stream through the communication event interface.

There are many possible embodiments and applications for using a share button according to aspects of the present invention. Commercial Web sites may install share buttons associated with advertisements and other information. Music, video, and blogging sites can install share buttons for sharing content and functional control of the content. In one embodiment of the present invention interactivity with shared content may be tracked and reported back to the client and controller of the content being shared in the form of one or more analytic reports that may be characterized by graphs, bar charts, tables, or other reporting interfaces. Client interface 130 of FIG. 1 may provide analytic views for the client relative to usage statistics including channel usage, widget views, click through activity relative to shared advertisements, content propagation statistics, and other similar statistical reports. Such reports may be ordered and viewed by clients of the service of the present invention.

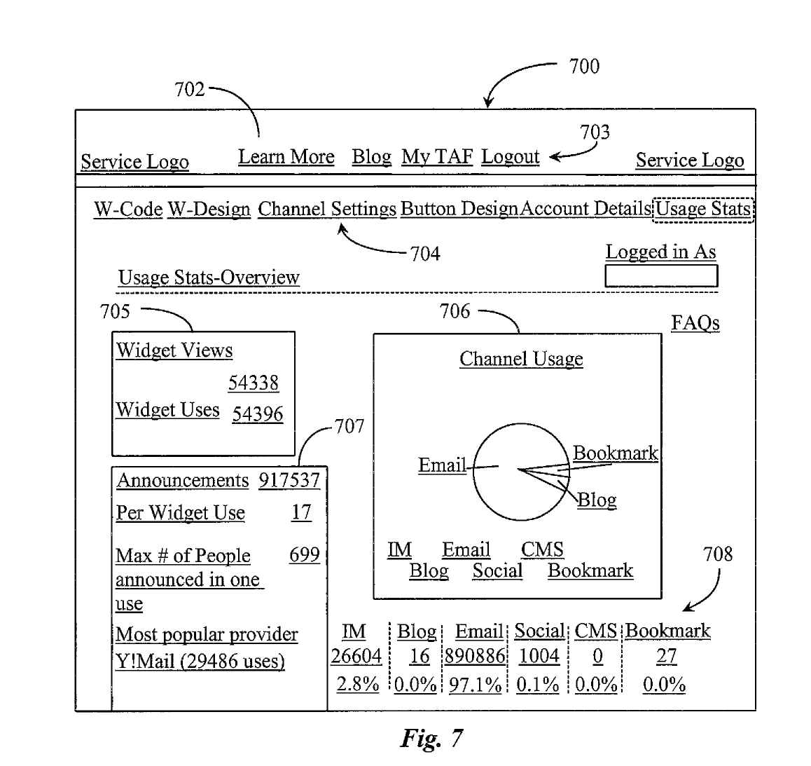

FIG. 7 is an exemplary screen shot of a service interface 700 for interacting with the service of the present invention. Interface 700 is analogous to client interface 130 of FIG. 1. Interface 700 is a Web interface in this example. Interface 700 includes a title bar 702 that includes one or more service logos of service providers and/or partners. Title bar 702 includes interactive menu options 703 enabling the client to navigate to other pages of the service site. Options include but are not limited to learning more, Blog page, My TAF page, and an option for Logout.

Further interactive menu options 704 are provided beneath title bar 702 including but not limited to accessing Widget code; accessing widget design tools; viewing channel settings; accessing button design tools; accessing account details; and viewing usage statistics. In this particular example, the interface is displaying a usage statistics overview in a dashboard style workspace. A statistics summary block 705 is provided and contains widget view statistics and widget usage statistics. A statistics summary block 707 is provided and contains statistics such as but not limited to total announcements; announcements per widget use; Maximum number of people announced in one use; and the most popular communications interface provider. Various other statistics may be reported and may be viewed on a summary information block on this overview page.

In this example a statistics summary block 706 is provided that displays various graphical charts according to several differing views relative to different statistical categories. In this example the view is a pie chart that compares overall channel usage for Email, Bookmarking; and Blogging. Below block 706, interface 700 includes an overall usage summary for Instant Message; Blog; Email; Social Networking site; CMC; and Bookmarking site. Overall usage relative to the client's widget is expressed in percentages of use with Email garnering 97.1% of the content sharing by visitors. In addition to pie charts, other types of graphical reports may be ordered and viewed including custom reports. Bar charts and line graphs detailing total shares for each of a number of channels over specific time periods may be ordered and viewed.

It will be apparent to one with skill in the art that the content sharing system of the invention may be provided using some or all of the mentioned features and components without departing from the spirit and scope of the present invention. It will also be apparent to the skilled artisan that the embodiments described above are specific examples of a single broader invention, which may have greater scope than any of the singular descriptions taught. There may be many alterations made in the descriptions without departing from the spirit and scope of the present invention.

What is claimed is:

1. A system for sharing interactive electronic information over a network and tracking the results of interaction with the information, the system comprising:
an executable code responsive to an executable button in an electronic form containing the electronic information to be shared;
a communication channel selection interface stored on a digital medium, the communication channel selection interface displayable as a result of interaction with the button; and
an activity tracking server having a digital medium for storing software and data, the tracking server including a reporting interface stored on the digital medium, the reporting interface accessible to a client sharing the information;
wherein a visitor to the electronic form containing the electronic information executes the code by interacting with the button to display the communications channel selection interface, and selects a communications channel from within the interface for sharing the electronic information with one or more persons and wherein the code executes to format and insert the electronic information into the selected communication vehicle, and wherein information distribution parameters and any resulting interaction with the shared information is tracked and recorded by the tracking server and made accessible to the client.

2. The system of claim 1 wherein the electronic information includes one or more of graphics displays, one or more text lines or blocks, universal resource locators (URLs) or hyperlinks.

3. The system of claim 1 wherein the electronic information includes navigational instruction for a recipient's browser to access the original location of the electronic information.

4. The system of claim 1 wherein the one or more persons are selected from an address book displayed from a third-party contact list relevant to the selected communications channel.

5. The system of claim 1 wherein the electronic information is contained on a Web page and the executable button gathers the electronic information and formats the information for suitable display according to the communications channel selected for sending the electronic information.

6. The system of claim 1 wherein the electronic information includes one of a Web image or a flash based image.

7. The system of claim 1 wherein the electronic information is an advertisement enabled for click-through interaction and includes a tracking code for tracking click-though activity.

8. The system of claim 1 wherein the electronic information includes sender identification data and a tracking code for tracking the identification data of one or more persons that the electronic information was shared with.

9. The system of claim 1 wherein the reporting interface enables graphical views of collected statistics about usage of the executable button, channel selection interface, and about resulting activity relative to remote interaction with the distributed electronic information.

10. The system of claim 9 wherein interaction with the electronic information at the point of a person receiving the electronic information causes re-direction of the person's browser to the original form containing the electronic information.

11. The system of claim 1 wherein the electronic information is a dynamic advertisement provided to the electronic form by an advertising server and wherein the executable button is automatically refreshed each time a different advertisement is served to the electronic form.

12. A method for advertising comprising the steps:
(a) providing at least one advertisement in electronic form;
(b) associating to the advertisement, an executable button for gathering and utilizing data relative to the advertisement and use thereof; and
(c) facilitating through the executable button, communication of the advertisement data in interactive format to one or more intended recipients.

13. The method of claim 12 wherein in step (a) the advertisement is one of a static graphical advertisement, a java script graphical advertisement, or a flash based graphical advertisement.

14. The method of claim 13 wherein the graphical portion of the advertisement is a still graphic or an animation.

15. The method of claim 12 wherein in step (b) the executable button is overlaid onto the advertisement graphics.

16. The method of claim 12 wherein in step (b) the executable button is placed adjacent to but not touching the advertisement graphics.

17. A method for facilitating a referral through propagation of an electronic advertisement comprising the steps:
(a) providing an advertisement in electronic form;
(b) associating to the advertisement, an executable button for gathering and utilizing data relative to the advertisement and use thereof;
(c) facilitating through visitor interaction with the executable button, communication of the advertisement data in interactive format to one or more intended recipients;
(d) redirecting the one or more recipient's browsers to the original advertisement upon interaction with the advertisement data communicated to the one or more recipients; and
(e) tracking and recording activity relative to one or more recipients interacting with the advertisement.

18. The method of claim 17 wherein in step (b) a price structure including a discount for referring the advertisement is included in the data relative to the advertisement.

19. The method of claim 17 wherein in step (a) the advertisement is a click-through advertisement on a Web page.

20. The method of claim 17 wherein in step (e) activity includes click-through data that is recorded on a digital medium accessible to a tracking server and reporting interface.
